(19) United States
(12) Patent Application Publication
(10) Pub. No.: US 2016/0039182 A1
(43) Pub. Date: Feb. 11, 2016

(54) Bearing Substrate and Manufacturing Method of Flexible Display Device

(71) Applicant: BOE TECHNOLOGY GROUP CO., LTD., Beijing (CN)

(72) Inventor: Huifeng WANG, Beijing (CN)

(73) Assignee: BOE TECHNOLOGY GROUP CO., LTD., Beijing (CN)

(21) Appl. No.: 14/420,748

(22) PCT Filed: Mar. 25, 2014
(86) PCT No.: PCT/CN2014/074037

§ 371 Date: Feb. 10, 2015

(30) Foreign Application Priority Data
Dec. 9, 2013 (CN) 201310662795.8

(51) Int. Cl. B32B 17/06; B32B 9/04; B32B 43/00

(52) U.S. Cl. CPC B32B 17/06; B32B 43/006; B32B 9/04; B32B 2457/20

(57) ABSTRACT

The present invention provides a bearing substrate used for carrying a flexible film of a flexible display device in the process of manufacturing the flexible display device. The bearing substrate comprises a substrate and a gas generation layer located on the substrate. In the process of manufacturing the flexible display device, the flexible film is located on the gas generation layer, and the material of the gas generation layer can be decomposed to generate gas. Correspondingly, the present invention further provides a manufacturing method of a flexible display device. In the present invention, after display elements on a flexible film have been manufactured, the flexible film can be separated from the substrate; meanwhile, in the present invention, both the stripping manner of flexible film and the separation force of stripping the flexible film from the substrate can be flexibly adjusted.

### FIELD OF THE INVENTION

The present invention relates to the field of display technology, and particularly relates to a bearing substrate and a manufacturing method of a flexible display device.

### BACKGROUND OF THE INVENTION

Nowadays, flexible materials have been gradually applied in the field of display technology. Compared with conventional flat display screens, flexible display screens can be bent or folded. As a result, the flexible display screens have a broad application prospect.

Generally, flexible display devices are obtained by manufacturing display elements on flexible films. However, the high temperature required in the process of manufacturing display elements on flexible films is likely to result in the deformation of the flexible films and thus to cause failed processing. Therefore, in an existing method, a flexible film is generally manufactured on a rigid glass substrate, then display elements are manufactured on the flexible film, and the flexible film is separated from the glass substrate after the display elements have been manufactured.

In an existing method for separating a flexible film from a glass substrate, a metal layer, an oxide layer and a hydrogen-contained semiconductor are manufactured on the glass substrate, and then hydrogen is released from the semiconductor by thermal treatment, so that there is an oxidation-reduction reaction happened in the oxide layer. As a result, the adhesion force between the oxide layer and the metal layer is reduced, and the flexible film is thus stripped from the glass substrate. In another existing method, a hot-melt resin layer is formed between a flexible film and a glass substrate, and the hot-melt resin is melt by heating during stripping, so that the flexible film is separated from the glass substrate.

However, as a high-temperature process will be often employed in the process of manufacturing display elements on a flexible film, hydrogen is likely to be diffused in advance in the existing method using a hydrogen-containing semiconductor, so that the subsequent stripping is not sufficient; or, the hot-melt resin is likely to be melt in advance in the existing method using a hot-melt resin, so that the processing of the whole flexible display device fails.

### SUMMARY OF THE INVENTION

In view of the above problems, an objective of the present invention is to provide a bearing substrate and a manufacturing method of a flexible display device. Hereby, a flexible film may be separated from the substrate after display elements on the flexibly film have been manufactured.

To achieve the above objective, the present invention provides a bearing substrate used for carrying a flexible film of a flexible display device in the process of manufacturing the flexible display device, wherein the bearing substrate includes a substrate and a gas generation layer located on the substrate, wherein the flexible film is located on the gas generation layer in the process of manufacturing the flexible display device, and the material of the gas generation layer is able to be decomposed to generate gas.

Preferably, by irradiating the gas generation layer using laser beams, the gas generation layer absorbs the energy of the laser beams and is then decomposed to generate the gas.

Preferably, the band-gap energy of the material of the gas generation layer is 2 eV-7 eV.

Preferably, the material of the gas generation layer includes GaN or AlN, or the material of the gas generation layer includes a mixture of GaN and AlN.

Preferably, the gas generation layer further includes photothermal conversion material.

Preferably, the band-gap energy of the material of the substrate is greater than 7 eV.

Preferably, the material of the substrate is glass or transparent ceramics.

Preferably, the thickness of the gas generation layer is 10 nm-100 μm.

Preferably, the thickness of the gas generation layer is 200 nm-500 nm.

Correspondingly, the present invention further provides a manufacturing method of a flexible display device, including the following steps:

forming a gas generation layer on a substrate, wherein the material of the gas generation layer is able to be decomposed to generate gas;

forming a flexible film on the gas generation layer;

forming a display element layer on the flexible film; and

causing the material of the gas generation layer to be decomposed to generate gas, so that the flexible film is separated from the substrate.

Preferably, the step of causing the material of the gas generation layer to be decomposed to generate gas includes: irradiating the gas generation layer by using laser beams, so that the gas generation layer absorbs the energy of the laser beams and is then decomposed to generate the gas.

Preferably, the laser beams are caused to irradiate along a predetermined path, so as to pass through the substrate and then irradiate on the gas generation layer.

Preferably, the laser beams are caused to irradiate in a direction from one side of the gas generation layer to the other side opposite to the one side in a scanning manner, so as to pass through the substrate and then irradiate on the gas generation layer.

Preferably, the laser beams are caused to irradiate in a direction from the edge of the gas generation layer to the center of the gas generation layer in a scanning manner, so as to pass through the substrate and then irradiate on the gas generation layer.

It can be seen that, in the present invention, by arranging a gas generation layer between a substrate and a flexible film, the gas generation layer can be decomposed to generate gas when it is required to strip the flexible film, so that the flexible film is forced to be separated from the substrate due to the expansion of the gas. Compared with the prior art, the present invention can realize a good separation effect between the flexible film and the substrate. Meanwhile, the gas generation layer in the present invention may have good heat resistance, so that the problem in the prior art that hydrogen is diffused in advance or hot-melt resin is melt in advance in a high-temperature environment during processing a display device can be overcome. In addition, in the present invention, the stripping manner of the flexible film can be flexibly adjusted by controlling the scanning manner of laser beams, and the separation force between the flexible film and the substrate can also be adjusted by controlling the thickness of the gas generation layer.

### BRIEF DESCRIPTION OF THE DRAWINGS

The accompanying drawings are used for providing further understanding of the present invention, and constitute a part of the specification. The accompanying drawings are used for explaining the present invention together with the following embodiments, but are not intended to limit the present invention. In the drawings:

FIG. 1 is an exemplary structural diagram of a bearing substrate and a flexible display device carried on the bearing substrate according to the present invention;

FIG. 2 is a flowchart of a manufacturing method of a flexible display device according to the present invention;

FIG. 3 is an exemplary side view illustrating an irradiation direction of laser beams according to the present invention; and

FIG. 4 is an exemplary bottom view illustrating a scanning manner of laser beams according to the present invention.

Reference numerals: 101 Substrate; 102 Gas generation layer; 103 Flexible film; 104 Display element layer; and, 201 Laser beams.

### DETAILED DESCRIPTION OF THE EMBODIMENTS

Embodiments of the present invention will be described below in details with reference to the accompanying drawings. It should be understood that, the embodiments described herein are merely used for describing and explaining the present invention, but are not intended to limit the present invention.

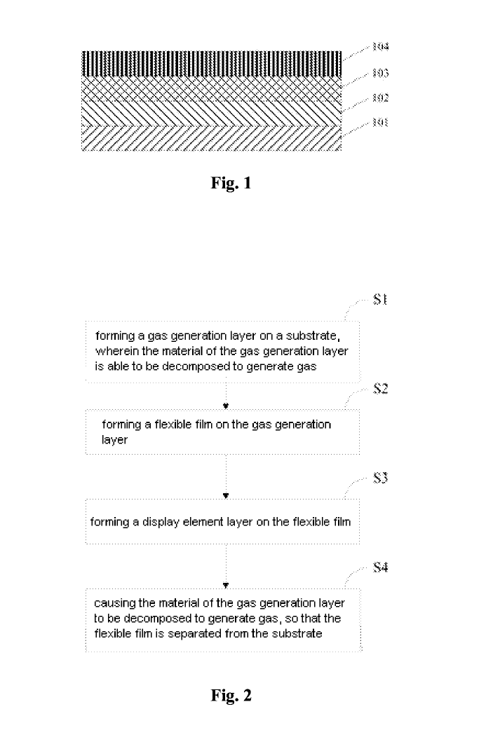

As one aspect of the present invention, a bearing substrate is provided. In the process of manufacturing a flexible display device, the bearing substrate can be used for carrying the flexible display device thereon. Specifically, as shown in FIG. 1, the bearing substrate for manufacturing the flexible display device may include a substrate 101 and a gas generation layer 102, and the flexible display device carried on the bearing substrate may include a flexible film 103 and a display element layer 104. Wherein, the gas generation layer 102 is located on the substrate 101, the flexible film 103 is located on the gas generation layer 102, and the material of the gas generation layer 102 is able to be decomposed to generate gas.

Specifically, as shown in FIG. 1, to ensure that the flexible film 103 can be stripped from the substrate 101 after the display element layer 104 is processed on the flexible film 103, in the bearing substrate for manufacturing a flexible display device provided by the present invention, the gas generation layer 102 is manufactured on the substrate 101, so that the gas generation layer 102 is located between the substrate 101 and the flexible film 103. As the material of the gas generation layer 102 is able to be decomposed to generate gas under certain conditions, the flexible film 103 may be separated from the substrate 101 due to the expansion of the gas. Specifically, the conditions of activating the gas generation layer 102 to be decomposed to generate gas may be determined according to actual requirements.

In the present invention, the separation of the flexible film 103 from the substrate 101 due to the expansion of a gas employs a separation principle different from the prior art, and a better separation effect can be achieved by the expansion of the gas. Meanwhile, since the gas generation layer 102 in the present invention may have good heat resistance, the gas generation layer 102 will not be decomposed in advance in the high-temperature processing environment of manufacturing a display device, and the problem in the prior art that hydrogen is diffused in advance or hot-melt resin is melt in advance in the high-temperature environment of processing a display device can be overcome.

Furthermore, the gas generation layer 102 may be irradiated by using laser beams, so that the gas generation layer 102 absorbs the energy of the laser beams and is then decomposed to generate gas. In this case, the band-gap energy of the material of the gas generation layer 102 may be from 2 eV to 7 eV. This is because the gas generation layer 102 may readily absorb the energy of the laser beams and then be decomposed to generate gas when the band-gap energy of the material of the gas generation layer 102 is smaller. Therefore, preferably, the band-gap energy of the material of the gas generation layer 102 may be from 2 eV to 7 eV, and the used laser beams may be laser beams within an ultraviolet band. As the energy of the laser beams within the ultraviolet band is high, it is sufficient to cause the gas generation layer 102 to be decomposed to generate gas.

The material for manufacturing the gas generation layer 102 may be a material capable of generating and releasing gas under the irradiation of laser beams. Preferably, the material for manufacturing the gas generation layer 102 may include GaN or AlN, or a mixture of GaN and AlN. The band-gap energy of GaN is 3.3 eV and the band-gap energy of AlN is 6.3 eV, so that the two may absorb the energy of laser beams and may be then decomposed to generate gas N₂ and corresponding metals after being irradiated by laser beams. Thus the flexible film 103 may be separated from the substrate 101 due to the expansion of the generated gas N₂. Meanwhile, both GaN and AlN have good heat resistance. For example, the interfacial decomposition temperature of GaN is 900° C., while the high-temperature environment during manufacturing the display element layer 104 is generally between 300° C. and 400° C. Therefore, the gas generation layer 102 made of GaN or AlN may be remained stable in the high-temperature environment of manufacturing the display element layer 104. In addition, by using the gas generation layer 102 made of GaN or AlN or the mixture thereof, the substance (Ga or Al) obtained by the decomposition of the gas generation layer 102 is strongly adhered to the substrate 101 ratherthan to the flexible film 103, so that the decomposed substance may be prevented from remaining on the flexible film 103.

It is to be noted that, an auxiliary material may also be added to the gas generation layer 102 so as to facilitate the gas generation layer 102 to absorb the energy of laser beams. For example, a photothermal conversion material may be added to the gas generation layer 102.

Furthermore, the band-gap energy of the material of the substrate 101 is greater than 7 eV. Specifically, the band-gap energy of the material of the substrate 101 may be large, so as to be difficult to absorb the energy of laser photons. Generally, the energy of photons of laser beams within the ultraviolet band is between 3 eV and 7 eV. Therefore, preferably, the band-gap energy of the material of the substrate 101 may be greater than 7 eV, so that the energy of the laser beams within the ultraviolet band may be transmitted to the gas generation layer 102 through the substrate 101.

Preferably, the material of the substrate 101 may be glass or transparent ceramics. The glass or transparent ceramics has larger band-gap energy and are unlikely to absorb the energy of laser photons. Meanwhile, as the material is transparent, the laser beams may be allowed to pass through the substrate 101 and thus irradiate on the gas generation layer 102.

Furthermore, in the bearing substrate for manufacturing a flexible display device provided by the present invention, the thickness of the gas generation layer is 10 nm-100 μm. Specifically, the thickness of the gas generation layer 102 may be determined by a force for separating the flexible film 103 from the substrate 101. When the force for separating the flexible film 103 from the substrate 101 is relatively large, the gas generation layer 102 having a relatively large thickness may be provided, so that a larger amount of gas may be generated after the gas generation layer 102 is decomposed, and a larger separation force is thus provided. Correspondingly, when the force for separating the flexible film 103 from the substrate 101 is relatively small, the gas generation layer 102 having a relatively small thickness may be provided, so that a smaller amount of gas may be generated after the gas generation layer 102 is decomposed, and a smaller separation force is thus provided. It is to be noted that, to avoid explosion due to the excessive generated gas, the thickness of the gas generation layer 102 should not be too large, so the thickness of the gas generation gas 102 may be between 10 nm-100 μm. Preferably, the thickness of the gas generation gas 102 may be between 200 nm and 500 nm.

As one aspect of the present invention, a manufacturing method of a flexible display device is provided. In the method, a flexible display device may be manufactured by using the above bearing substrate provided by the present invention. Specifically, as shown in FIG. 2, the manufacturing method of a flexible display device may include the following steps:

S1: forming a gas generation layer on a substrate, wherein the material of the gas generation layer is able to be decomposed to generate gas;

S2: forming a flexible film on the gas generation layer;

S3: forming a display element layer on the flexible film; and

S4: causing the material of the gas generation layer to be decomposed to generate gas, so that the flexible film is separated from the substrate.

Preferably, the gas generation layer 102 may be irradiated by laser beams, so that the gas generation layer 102 absorbs the energy of the laser beams and is then decomposed to generate gas. The energy of photons of laser beams is relatively high, so it is sufficient to cause the gas generation layer 102 to be decomposed to generate gas after absorbing energy. Meanwhile, the laser beams have high directionality, so it is convenient to control the irradiation positioning to the gas generation layer 102. Specifically, laser beams within the ultraviolet band may be employed.

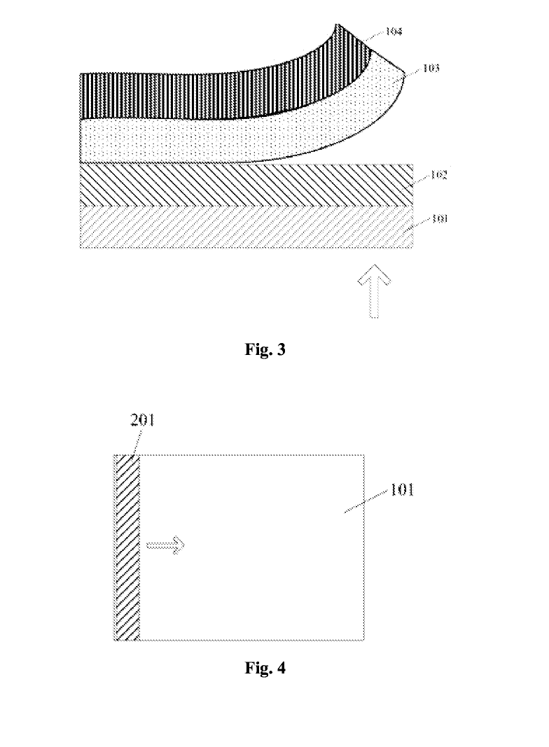

Furthermore, as shown in the side view of FIG. 3, when the gas generation layer 102 is irradiated by laser beams, the laser beams may pass through the substrate 101 along a predetermined path (i.e., the arrow in FIG. 3 shows an irradiation direction from the bottom to top and an irradiation position of the laser beams), and then irradiate on the gas generation layer 102.

Preferably, as shown in the bottom view of FIG. 4, as the gas generation layer 102 (not shown in the figure) is arranged on the substrate 101 in an inward direction vertical to a principal plane, as described above, irradiation is performed in a scanning manner in a direction from one side (for example, the left side in FIG. 4) of the gas generation layer 102 to the other side (for example, the right side in FIG. 4) opposite to the one side by using laser beams (i.e., the arrow in FIG. 4 shows the scanning direction when irradiation is performed by using laser beams 201), so that the laser beams pass through the substrate 101 and then irradiate on the gas generation layer 102.

Or, the irradiation may also be performed in a scanning manner in a direction from the edge of the gas generation layer 102 to the center of the gas generation layer 102 by using laser beams, so that the laser beams pass through the substrate 101 and then irradiate on the gas generation layer 102.

Through the above ways, the separation manner of the flexible film 103 and the substrate 101 may be flexibly controlled according to actual requirements. By controlling the scanning and irradiation manner of laser beams, the separation of the flexible film 103 from the substrate 101 from one side to the other side or the separation of the flexible film 103 from the substrate 101 from the edge to the center of the flexible film 103 is realized. Thus, multiple manners of separating the flexible substrate from the bearing substrate are realized.

The bearing substrate for manufacturing a flexible display device and corresponding manufacturing method of a flexible display device provided by the present invention have been described above. It can be seen that, in the present invention, by arranging a gas generation layer between a substrate and a flexible film, the gas generation layer can be decomposed to generate gas when it is required to strip the flexible film, so that the flexible film is forced to be separated from the substrate due to the expansion of the gas. Compared with the prior art, the gas generation layer in the present invention may have good heat resistance, so that the problem in the prior art that hydrogen is diffused in advance or hot-melt resin is melt in advance in a high-temperature environment during processing a display device can be overcome. Meanwhile, in the present invention, the stripping manner of the flexible film may be flexibly adjusted by controlling the scanning manner of laser beams, and the separation force between the flexible film and the substrate may also be adjusted by controlling the thickness of the gas generation layer.

It should be understood that the foregoing implementations are merely exemplary implementations for illustrating the principle of the present invention, but the present invention is not limited thereto. Those of ordinary skill in the art may make various variations and improvements without departing from the spirit and essence of the present invention, and these variations and improvements are also deemed as falling within the protection scope of the present invention.

1-14. (canceled)

15. A bearing substrate for carrying a flexible film of a flexible display device in the process of manufacturing the flexible display device, wherein the bearing substrate comprises a substrate and a gas generation layer located on the substrate, wherein the flexible film is located on the gas generation layer in the process of manufacturing the flexible display device, and the material of the gas generation layer is able to be decomposed to generate gas.

16. The bearing substrate according to claim 15, wherein, by irradiating the gas generation layer using laser beams, the gas generation layer absorbs the energy of the laser beams and is then decomposed to generate gas.

17. The bearing substrate according to claim 16, wherein the band-gap energy of the material of the gas generation layer is 2 eV-7 eV.

18. The bearing substrate according to claim 17, wherein the material of the gas generation layer comprises GaN or AlN, or the material of the gas generation layer comprises a mixture of GaN and AlN.

19. The bearing substrate according to claim 18, wherein the gas generation layer further comprises a photothermal conversion material.

20. The bearing substrate according to claim 17, wherein the band-gap energy of the material of the substrate is greater than 7 eV.

21. The bearing substrate according to claim 20, wherein the material of the substrate is glass or transparent ceramics.

22. The bearing substrate according to claim 15, wherein the thickness of the gas generation layer is 10 nm-100 μm.

23. The bearing substrate according to claim 16, wherein the thickness of the gas generation layer is 10 nm-100 μm.

24. The bearing substrate according to claim 17, wherein the thickness of the gas generation layer is 10 nm-100 μm.

25. The bearing substrate according to claim 18, wherein the thickness of the gas generation layer is 10 nm-100 μm.

26. The bearing substrate according to claim 19, wherein the thickness of the gas generation layer is 10 nm-100 μm.

27. The bearing substrate according to claim 20, wherein the thickness of the gas generation layer is 10 nm-100 μm.

28. The bearing substrate according to claim 21, wherein the thickness of the gas generation layer is 10 nm-100 μm.

29. The bearing substrate according to claim 22, wherein the thickness of the gas generation layer is 200 nm-500 nm.

30. A manufacturing method of a flexible display device, comprising the following steps:
forming a gas generation layer on a substrate, wherein the material of the gas generation layer is able to be decomposed to generate gas;
forming a flexible film on the gas generation layer;
forming a display element layer on the flexible film; and
causing the material of the gas generation layer to be decomposed to generate gas, so that the flexible film is separated from the substrate.

31. The manufacturing method of a flexible display device according to claim 30, wherein the step of causing the material of the gas generation layer to be decomposed to generate gas comprises: irradiating the gas generation layer by using laser beams, so that the gas generation layer absorbs the energy of the laser beams and is then decomposed to generate the gas.

32. The manufacturing method of a flexible display device according to claim 31, wherein the laser beams are caused to irradiate along a predetermined path, so as to pass through the substrate and then irradiate on the gas generation layer.

33. The manufacturing method of a flexible display device according to claim 32, wherein the laser beams are caused to irradiate in a direction from one side of the gas generation layer to the other side opposite to the one side in a scanning manner, so as to pass through the substrate and then irradiate on the gas generation layer.

34. The manufacturing method of a flexible display device according to claim 33, wherein the laser beams are caused to irradiate in a direction from the edge of the gas generation layer to the center of the gas generation layer in a scanning manner, so as to pass through the substrate and then irradiate on the gas generation layer.
